(19) United States
(12) Patent Application Publication
(10) Pub. No.: US 2006/0185488 A1
(43) Pub. Date: Aug. 24, 2006

(54) Blade assembly

(76) Inventors: R. Stanford Short, Bryan, OH (US); Michael S. Evans, Camden, MI (US); Patrick G. Blad, Stryker, OH (US); Lonny R. Breen, Defiance, OH (US)

Correspondence Address: INDIANAPOLIS OFFICE 27879;BRINKS HOFER GILSON & LIONE, ONE INDIANA SQUARE, SUITE 1600, INDIANAPOLIS, IN, 46204-2033, US

(21) Appl. No.: 11/334,616

(22) Filed: Jan. 18, 2006

Related U.S. Application Data
(60) Provisional application No. 60/645,058, filed on Jan. 19, 2005.

(51) Int. Cl. B21K 5/00; B26D 5/00

(52) U.S. Cl. 83/581.1; 83/662; 83/858; 83/932; 76/119

(57) ABSTRACT

A blade assembly for use in a slicing device comprises a plurality of blades and a pair of tension members. Each of the tension members has a plurality of slots formed therein. The tension members are positioned in the assembly such that the slots in one tension member are disposed generally opposite the slots in the other tension member. The tension members are spaced such that a longitudinal end of a blade is received in each of the generally opposite slots, in a manner such that the blades are maintained between the tension members under tension. A retainer is associated with each of the tension members for retaining the blade longitudinal end in the tension member slot. A spacer is provided to maintain the spacing between the tension members, to thereby maintain the tension in the blades.

### RELATED APPLICATION

The present patent document claims the benefit of the filing date under 35 U.S.C. §119(e) of Provisional U.S. Patent Application Ser. No. 60/645,058, filed Jan. 19, 2005, which is hereby incorporated by reference.

### BACKGROUND

1. Technical Field

The present invention is directed to a blade assembly. More particularly, the invention is directed to a novel blade assembly for use in a slicing machine, and to a slicing machine that incorporates the novel blade assembly.

2. Background Information

Many slicing machines are commercially available for slicing food products, such as produce. Currently there are two general types of produce slicers that have blade assemblies made up of multiple blades. One type has a blade set that comprises a plurality of blades that are individually installed into the machine in a loose condition. The individual blades are placed in tension by tightening screws against receiving members positioned along the frame of the machine. This is the most common style of machine presently available. However, this machine requires a heavy, strong frame that is capable of withstanding the initial blade tension and the additional tensile load that results from the cutting action. In addition, this construction is inconvenient for the user when worn or damaged blades must be replaced. In order to replace such blades, the individual blades must be removed from the frame. This action requires sufficient mechanical aptitude to ensure that the blades are safely and properly removed, and also requires that appropriate tools and replacement blades are readily available to enable the task to be successfully completed.

The second type of produce slicer is comparatively new in the marketplace, and is primarily used to slice tomatoes. This type has a unitized blade system, in which the blades are under tension within a frame, separate from the machine into which it the blade system is to be mounted. Machines of this type, to date, have unitized blade systems that are not repairable. These blade systems have inefficient material usage as they are generally machined from a single block of material, from which material is removed from the inner portion of the block to provide the frame. This generates material waste and results in increased costs for replacement. These blade systems require extensive and difficult machining during manufacture. Additionally, the cutting machine must be precisely formed to be able to accept and properly position the blade system. These shortcomings result in increased manufacturing costs for such devices.

It is desired to provide a food slicer having a blade assembly that is readily removable and replaceable in the food slicer, and in which the blades in the blade assembly may be replaced. It is further desired to provide a food slicer that may be readily repaired if desired, that may be utilized with a relatively light weight slicing machine, and that may be produced at a low cost.

### BRIEF SUMMARY

The present invention addresses the problems associated with prior art slicers. In one form thereof, the present invention comprises a blade assembly for use in a slicing device. The inventive blade assembly includes a plurality of blades and a pair of tension members, each tension member having a plurality of slots formed therein. The tension members are positioned such that the slots in one tension member are disposed generally opposite the slots in the other tension member, and are spaced such that a longitudinal end of a blade is received in each of the generally opposite slots in a manner such that the blade is maintained between the tension members under tension. A retainer is associated with each of the tension members for retaining a respective blade longitudinal end in the tension member slot. A spacer is provided for maintaining the spacing between the tension members to maintain the blade tension.

The present invention, in another form thereof, comprises a method for forming a blade assembly. In the inventive method, a pair of tension members is initially provided. Each tension member has a plurality of blade-receiving slots formed therein, an opening for receiving a spacer, and a hole longitudinally extending through at least a portion of the tension member, which hole passes through the blade-receiving slots. The tension members are aligned such that the blade-receiving slots in each tension member face each other. A plurality of cutting blades is provided, each blade having opposing longitudinal ends and having an aperture at each of the longitudinal ends. One longitudinal end of each blade is inserted into a respective blade-receiving slot in one tension member, and the other longitudinal end of each blade is inserted into the opposing blade-receiving slot in the other tension member in a manner such that the blade apertures are aligned with the hole extending through a respective tension member. A respective elongated member is inserted through each tension member hole and aligned blade aperture. The tension members having the blades inserted therein are aligned in a fixture, and the fixture is activated to controllably increase the spacing between the tension members to establish a tension in the blades, and to create sufficient distance between the tension members such that a spacer can be inserted between corresponding spacer openings to maintain a desired spacing. A spacer having sufficient strength for maintaining a selected distance between the tension members is inserted into the spacing between opposing tension members. The fixture is then adjusted to allow the tension members to move toward each other a specified distance to seat the spacer in the corresponding spacer openings, and to maintain a desired tension in the blades.

The present invention, in still another form thereof, comprises a food slicing device. The food slicing device comprises a frame, and a blade assembly removably receivable in the frame. The blade assembly includes a plurality of blades, and a pair of tension members. Each tension member has a plurality of blade-receiving slots formed therein. The tension members are positioned such that the slots in one tension member are disposed generally opposite the slots in the other tension member, and are spaced such that a longitudinal end of a blade is received in each of said generally opposite slots and maintained therein under tension. A retainer associated with each of the tension members retains a blade longitudinal end in a tension member slot. A spacer maintains the spacing between the tension members in a manner to maintain the tension in the blades.

### BRIEF DESCRIPTION OF THE DRAWINGS

FIG. 1 is a perspective view of a blade assembly according to an embodiment of the present invention;

FIG. 2 is a sectional view of the blade assembly taken along lines 2-2 of FIG. 1;

FIG. 3 is a perspective view of a tension block suitable for use in the blade assembly of FIG. 1;

FIG. 4 is a perspective view of one type of blade suitable for use in the blade assembly of FIG. 1;

FIG. 5 is a side view of a tension rod suitable for use in the blade assembly of FIG. 1;

FIG. 6 is a perspective view of one type of slicing machine that incorporates the blade assembly of FIG. 1;

FIG. 7 illustrates a fixture that may be used to establish tension in the blades during construction of the blade assembly;

FIG. 8 illustrates another type of slicing machine that incorporates a blade assembly of the present invention;

FIG. 9 is a perspective view of a food slicer according to an alternative embodiment of the present invention, wherein the blades are oriented horizontally when positioned in the slicer; and

FIG. 10 illustrates a sectional view of a blade assembly wherein the blades are oriented in a horizontal configuration for use in a food slicer.

### DETAILED DESCRIPTION OF THE DRAWINGS AND THE PRESENTLY PREFERRED EMBODIMENTS

For the purposes of promoting an understanding of the principles of the invention, reference will now be made to the embodiments illustrated in the figures, and specific language will be used to describe the same. It should nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

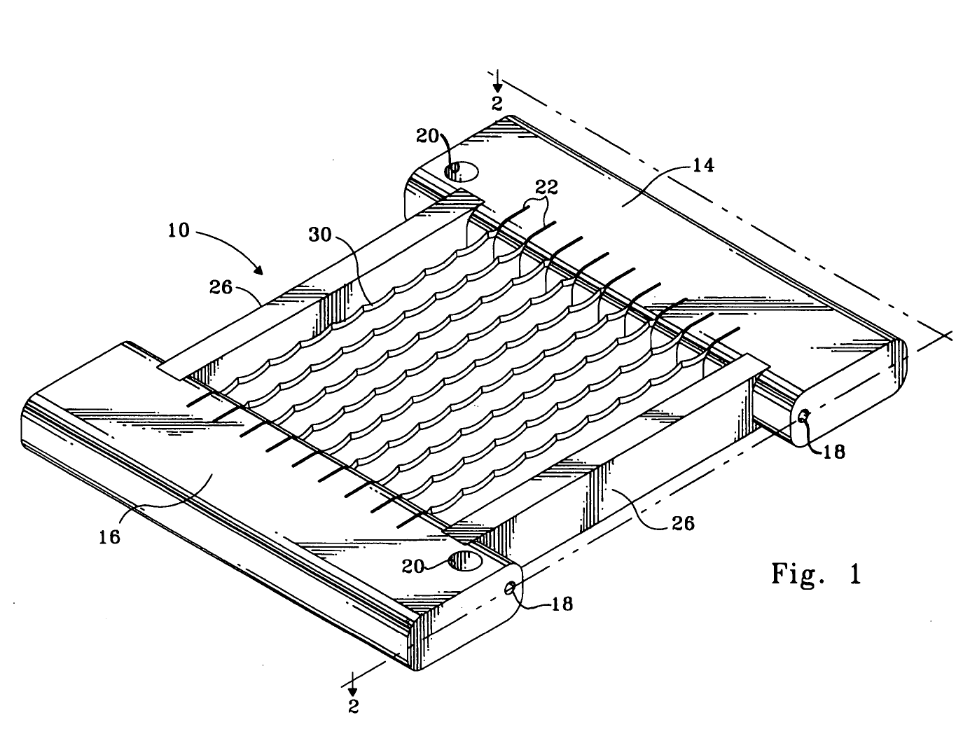

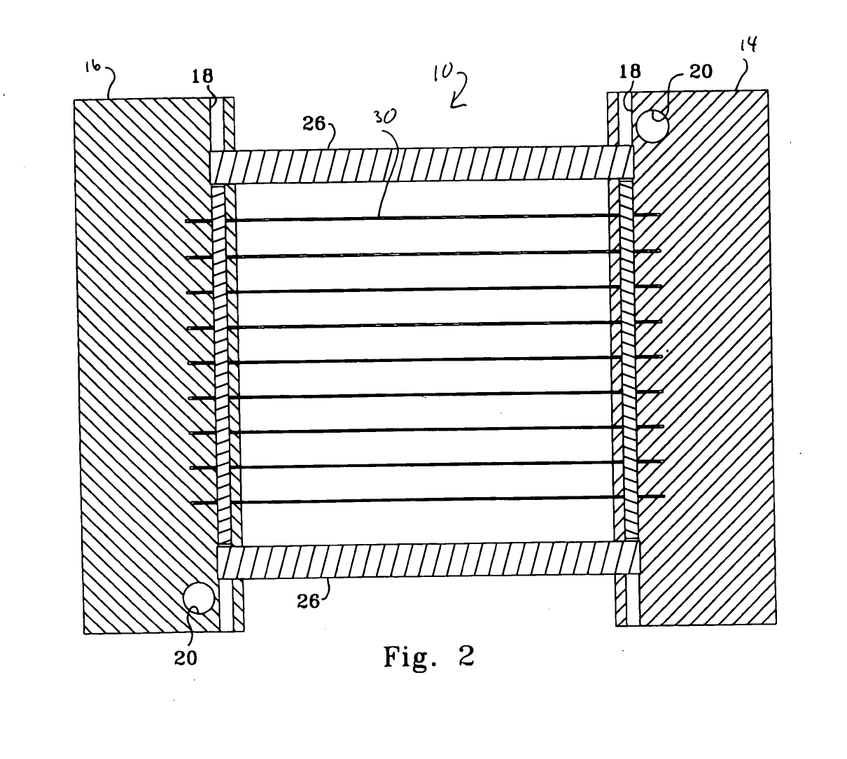

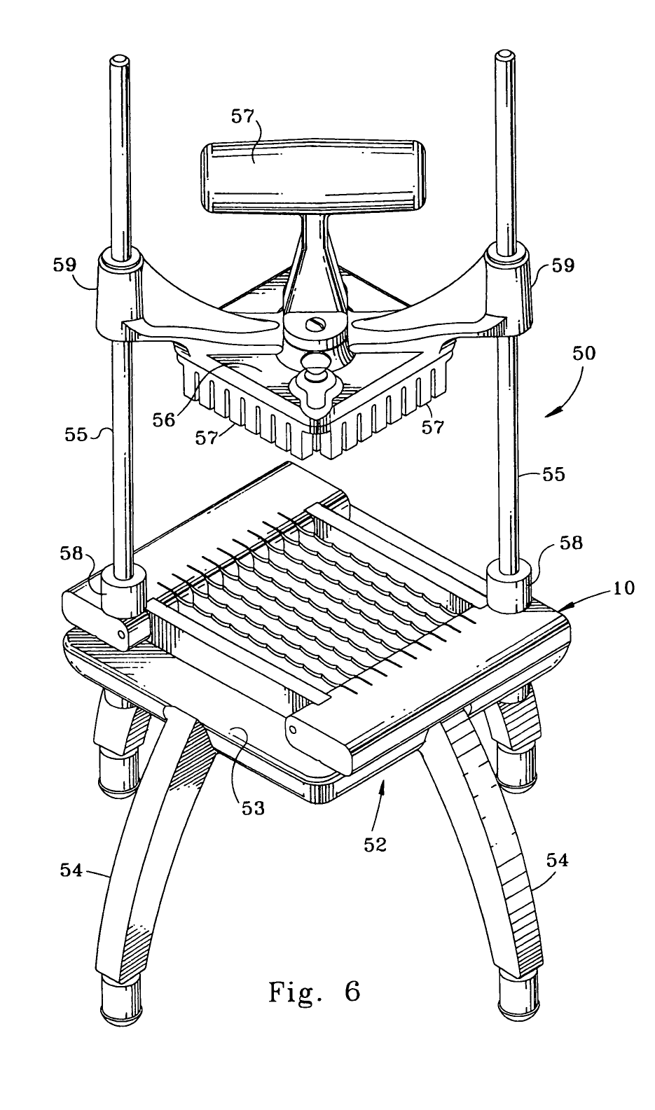

FIG. 1 illustrates a perspective view of a blade assembly 10, according to an embodiment of the present invention. FIG. 2 illustrates a sectional view of blade assembly 10, taken along lines 2-2 of FIG. 1. Although not limited to such use, blade assembly 10 may be incorporated into a slicer for use in slicing food products, such as produce. One non-limiting example of a type of food slicer in which the inventive blade assembly may be incorporated is illustrated in FIG. 6.

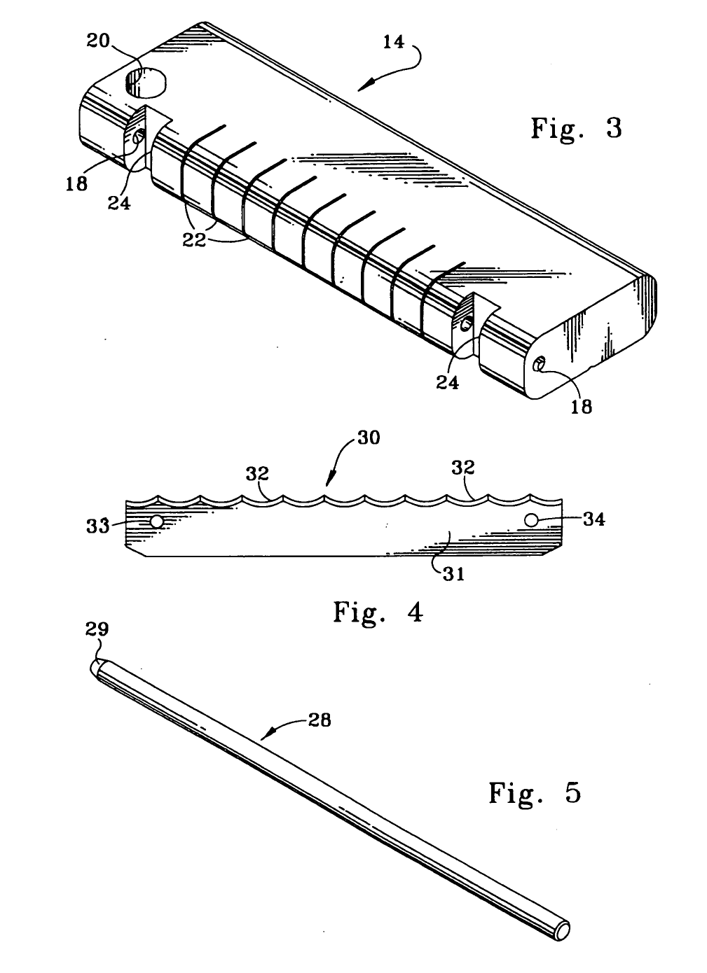

Blade assembly 10 includes a plurality of blades 30 mounted therein. Blades 30 span the distance between two opposing tension blocks 14, 16. An example of a suitable tension block is shown in FIG. 3. When arranged in blade assembly 10, tension blocks 14, 16 are spaced a defined distance from each other. Preferably, the tension blocks are formed of a lightweight metal, such as aluminum, that can be extruded or otherwise formed by conventional means to provide the desired shape, and that is capable of providing the requisite strength required for use in a food slicer.

Preferably, tension blocks 14, 16 are identical to each other, differing only in their relative position in the blade assembly. Thus, in the following discussion of the tension blocks, the same reference numeral is used to describe the corresponding feature in each tension block. A longitudinal hole 18 is extruded or otherwise cut through each of the respective tension blocks 14, 16. Longitudinal holes 18 are sized to receive a tension rod 28, in a manner to be discussed hereinafter. In a preferred embodiment, each tension block 14, 16 also includes another hole 20. Holes 20 may be machined or otherwise formed in each of the respective tension blocks 14, 16, and are provided for mounting blade assembly 10 to a suitable slicing device, such as food slicer 50 shown in FIG. 6. In the embodiment shown, holes 20 are oriented transverse to holes 18. Those skilled in the art will appreciate that holes 20 can alternatively be oriented at any other angle, depending upon the particular substrate in which blade assembly 10 is to be received, and the manner in which it is to be secured therein. Similarly, instead of holes 20, any other suitable structure for securely affixing the blade assembly to the substrate may be substituted.

Tension blocks 14, 16 are also provided with a plurality of narrow slots 22 for receiving the end of a blade. Additionally, at each axial end of the tension blocks, a wider slot 24 is provided for receiving a tension bar. The use of narrow slots 22 and wider slots 24 in forming blade assembly 10 will be discussed hereinafter. Although there are many possible ways to form tension blocks 14, 16, it is preferred to form them from a generally-solid blank. The blank may be initially extruded to have the general dimensions shown in FIG. 3, and to have hole 18 extending longitudinally therethrough. The tension block blank may then be machined by conventional methods to provide thin slots 22 for blade insertion, wider slots 24 for insertion of the tension bars, and mounting hole 20. If desired, one or more grooves (not shown) or other structure may be formed on the underside of the tension blocks for orientation purposes.

Blade assembly 10 includes a plurality of blades 30 that span the tension blocks 14, 16. The number of blades 30 in a particular blade assembly may be varied according to the slice thickness desired for the food product, such as produce, to be sliced. Preferably, however, the overall outside dimensions of blade assembly 10 will be constant for a particular cutting machine, regardless of the number of blades in the blade assembly. As a result, a cutting machine into which blade assembly 10 is to be inserted, such as produce slicer 50 illustrated in FIG. 6, can alternately receive blade assemblies having different numbers, and spacing, of blades. Thus, when relatively thin slices are desired, a blade assembly having a larger number of blades may be utilized in the machine. As a result, the blades are spaced relatively close together in the blade assembly, thus allowing thin slices to be cut. On the other hand, when thicker slices are desired, the blade assembly will include a smaller number of blades, and the blades will be spaced from each other a relatively greater distance than when thin slices are desired.

In order to accommodate different numbers of blades, the tension blocks are generally machined such that the number of slots 22 in the tension block corresponds to the number of blades in the blade assembly. Thus, for example, if it is desired to provide a blade assembly having nine blades spaced, e.g., ⅜ inch apart, then the tension block may be machined to include nine slots 22. This is the arrangement shown in FIG. 3. As another example, if it is desired to provide a blade assembly having thirteen blades spaced, e.g., ¼ inch apart, then the tension block may be machined to include thirteen slots. Those skilled in the art can readily determine an appropriate number of blades for a particular use, and the examples provided above are merely two of a myriad of possible numbers and orientations of blades that may be utilized in a blade assembly according to the present invention. 22. Those skilled in the art will appreciate that there are other ways in which slice thickness can be controlled, such as by designing a slicing machine having a blade assembly that is specifically sized for use with a particular number of blades. However, when respective blade assemblies having differing numbers of blades are provided in commonly-sized blade assemblies, the versatility of the cutting machine 50 is increased. With the inventive blade assembly, a single machine can be used to cut, e.g., ¼ inch, ⅜ inch or ½ inch slices by merely selecting an appropriate blade assembly.

Blades 30 may have any configuration common for use on food slicers. One example of a suitable blade 30 is illustrated in FIG. 4. In this embodiment, blade 30 has an elongated body 31, and has a serrated cutting edge 32. Although the blade is provided with a serrated cutting edge in the illustrated embodiment, this is merely one example of a type of cutting edge that may be utilized in the food slicer, and is not intended to limit in any manner the type and design of blade cutting edges that may be utilized in blade assembly 10. The particular design of cutting edge 32 to be employed may be varied, depending upon the type of food product to be sliced when using the food slicer and the inventive blade assembly. In the embodiment shown, blade 30 also includes apertures 33, 34. Apertures 33, 34 will be further discussed hereinafter with reference to the assembly of blade assembly 10. It is known to form cutting blades from many different compositions, and the cutting blades of the present invention are not limited to a single composition. In one particularly preferred embodiment, the cutting blades are formed from type 301 stainless steel.

The following discussion describes a preferred method for forming a blade assembly 10. Initially, tension blocks 14, 16 are placed on a surface with the blade slots 22 facing one another. When present, the grooves are oriented on the underside of the tension blocks. Blades 30 are then inserted in the properly aligned tension blocks in a manner such that each longitudinal end of a blade fits into a corresponding slot in one of the opposing tension blocks. Tension blocks 14, 16 and blades 30 are aligned such that aperture 33 of each respective blade 30 is aligned with longitudinal hole 18 of tension block 16, and aperture 34 of each respective blade 30 is aligned with longitudinal hole 18 of tension block 14. A suitable mechanism is provided to retain the blade ends in the tension blocks. In the preferred embodiment shown, this mechanism comprises a tension rod 28 (FIG. 5) that is slid into place in longitudinal hole 18 of tension block 16, and passed through each blade aperture 33 to retain the blade end in tension block 16. Tension rod 28 may be provided with a long chamfer 29 at one longitudinal end to assist in guiding the rod through the holes in the blade during assembly. Another tension rod is then slid into place in longitudinal hole 18 of tension block 14, and passed through blade aperture 34 to retain the blade end in tension block 14. The tension rods are precise diameter rod, cut to nominal length and deburred in conventional manner. Blades 30 are retained in position between tension bars 14, 16.

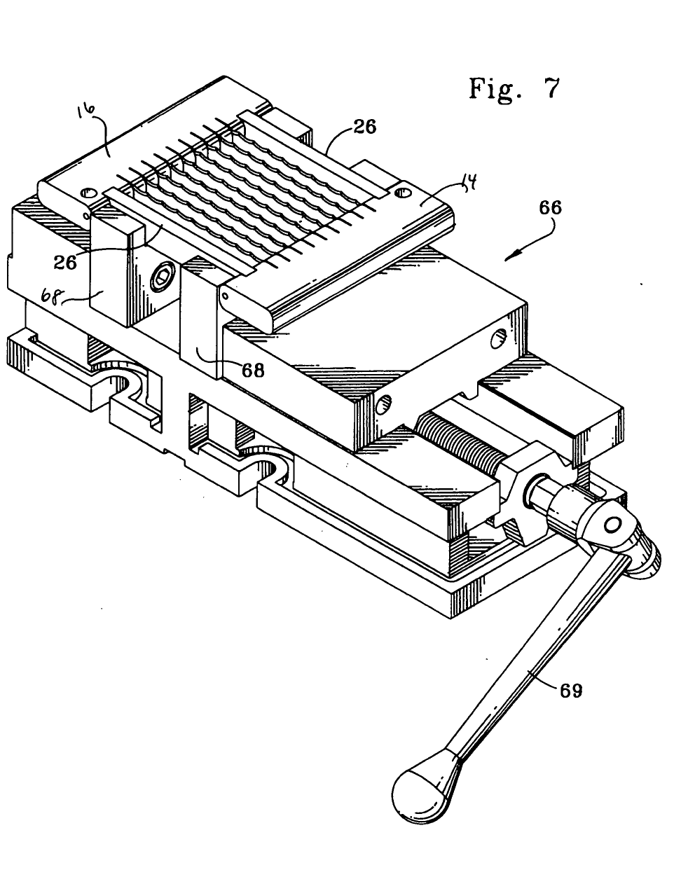

At this point the blades are fixed in the blade assembly in a loose manner, i.e., there is very little tension in the blades. The cutting ability of such loosely-fixed blades would be considerably inferior when compared to blades fixed in an assembly under tension. In general, the more tension that is created on a blade, the better the cutting ability of the blade. Thus, in order to create tension in the blades, the blade assembly is placed on a fixture from which a suitable amount of tension on the blades may be created. One example of a fixture 66 suitable for such use is illustrated in FIG. 7. In the figure, blade assembly 10 is mounted on fixture 66 for tensioning. In the example shown, fixture 66 is in the nature of a conventional vice. Fixture 66 includes appropriately-shaped vice jaws 68 that are movable via crank 69 to control the spacing between the respective jaws. As illustrated in FIG. 7, blade assembly 10 is positioned on fixture 66, and vice jaws 68 are aligned such that a separate jaw is adjacent to a separate one of tension blocks 14, 16.

As crank 69 of the fixture is rotated, the distance between the respective jaws increases. This increases the distance between respective tension blocks 14, 16, thereby “stretching” the blades and creating a tension therein. Preferably, the distance between tension blocks 14, 16 increases until the elastic limit of the blades is approached. At this point, the distance between the tension blocks 14, 16 is such that tension bars 26 can be inserted therebetween. In the example shown, the tension bars are inserted into tension bar cut-outs 24 at each end of blade assembly 10. Tension bars 26 are preferably formed of a metal block, such as 2024 aluminum, having sufficient strength to withstand the stresses created after fixture 66 is removed, and preventing the blades 30 from relaxing from their tensioned state. Those skilled in the art will appreciate that the tension bar(s) need not have the configuration shown in FIG. 7, and any conventional means of incorporating a member into a structure to maintain a desired spacing under tension may be substituted.

Once tension bars 26 have been inserted, the stress established by the fixture is slightly relaxed by rotating crank 69 in the opposite direction. The tension blocks retract slightly toward each other until the tension bars 26 are fully seated in the tension blocks. Once the tension bars are properly seated in the tension blocks, further axial movement of the tension blocks toward each other is precluded. The tension bars are sized to maintain the tension blocks a sufficient distance apart, to thereby maintain the stress, or tension, on the blades. Thus, it will be appreciated that in the inventive blade assembly 10, the blades 30 serve to hold the system together, while the tension bars 26 prevent the blades from losing their tension.

When positioned in a food slicing device, such as slicer 50 shown in FIG. 6, blade assembly 10 is positioned such that blades 30 are oriented vertically. Those skilled in the art will appreciate that numerous different designs of slicers can accommodate the blade assembly with the vertically-oriented blades, with slicer 50 being merely a preferred design, particularly for use in slicing produce. Slicer 50 includes a suitable frame 52. In the embodiment shown, frame 52 comprises a support surface 53, and a plurality of legs 54 that serve as supports for the frame. Frame 52 is preferably cast from aluminum, and includes apertures (not shown) that align with blade assembly holes 20 when the blade assembly is mounted in the frame. A pair of stainless steel guide rods 55 extend though holes 20 and the apertures in the frame for mounting the blade assembly to the frame. A suitable fastener, such as a grooved pin (not shown), is disposed on the underside of frame support surface 53 for fastening the guide rods 55, and thus the blade assembly 10, to frame 52.

Slicer 50 includes a push block 56 or similar mechanism to force the produce through the blade assembly. In the embodiment shown, push block 56 rides on guide rods 55. Push block 56 may be formed of any compatible material having the strength to push a food product through the blades of the blade assembly. Preferably, the push block is formed of a lightweight, low-friction and wear-resistant composition having sufficient strength and structural integrity to push the food product through the blades of the blade assembly. Those skilled in the art will appreciate that many suitable compositions may be utilized for such purposes. Non-limiting examples of such compositions include various plastics, such as acetal copolymers. DELRIN® and CELCON® are examples of particularly preferred plastics that may be utilized to form the push block.

Grippable handle 57 may be provided to allow for easy control of the push block as it is maneuvered up and down the guide rods. Preferably, elastomeric bumpers 58 are provided at the terminal end of the path of the guide rods. Bumpers 58 soften the impact of push block guide 59, and are sized to prevent the teeth 57 of push block 56 from directly engaging blades 20 during the downstroke of push block 56.

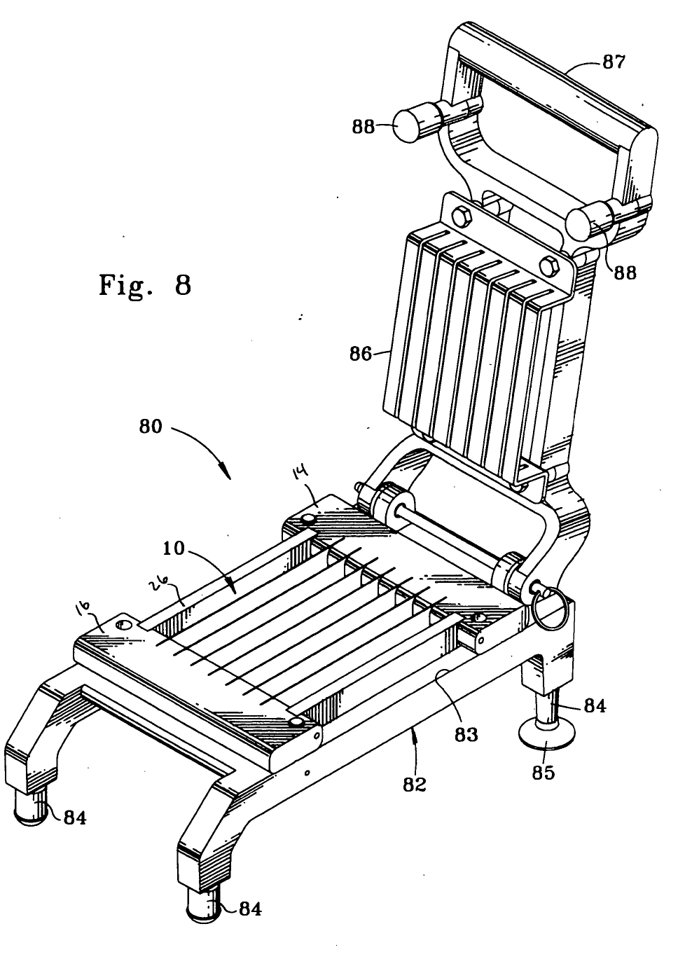

As stated, slicer 50 is merely one possible example of a slicing device upon which blade assembly 10 may be mounted. Those skilled in the art will appreciate that many other configurations are also suitable for use in conjunction with blade assembly 10. FIG. 8 illustrates another embodiment of a slicer 80 having blade assembly 10 fitted therein. The blade assembly shown in FIG. 8 includes 7 blades, spaced about ½ inch apart. The blades are oriented vertically, in the same manner in which blade assembly 10 is positioned in slicer 50. As stated, the number and spacing of blades can be varied depending upon the food product to be sliced. In this embodiment, slicer 80 includes a suitable frame 82. Frame 82 comprises a support surface 83, and a plurality of legs 84 that serve as supports for the frame. If desired, suction cups 85 can be positioned at the base of at least some of the legs to inhibit inadvertent movement of the slicer during use. Frame 82 is also preferably cast from aluminum, and includes apertures (not shown) that align with blade assembly holes 20 for mounting the blade assembly in the frame.

As illustrated in FIG. 8, slicer 80 has a lower profile than slicer 50. In addition, slicer 80 includes a push plate 86 that is pivotally connected to frame 82. Push plate 86 may be formed from the same or similar materials as push block 56. A suitable handle 87 is provided for selectively pivoting push plate 86 between the open position shown in FIG. 8, and a closed position. When the push plate is pivoted in this manner, a food product is subjected to a shearing-type cutting action as it is forced through the blade assembly. This type of cutting may be desirable when slicing a meat product, such as chicken.

As illustrated in FIG. 8, the cutting device may include a mechanism, such as crutch tips 88, for preventing the handle from directly impacting the frame at the end of a downstroke. In the embodiment shown, crutch tips 88 act in the nature of a bumper. This reduces the noise level of the operation, and may also inhibit excessive wear of the components. Other features of slicer 80 that have not been described herein are conventional, and further explanation is not required for a full understanding of the present invention.

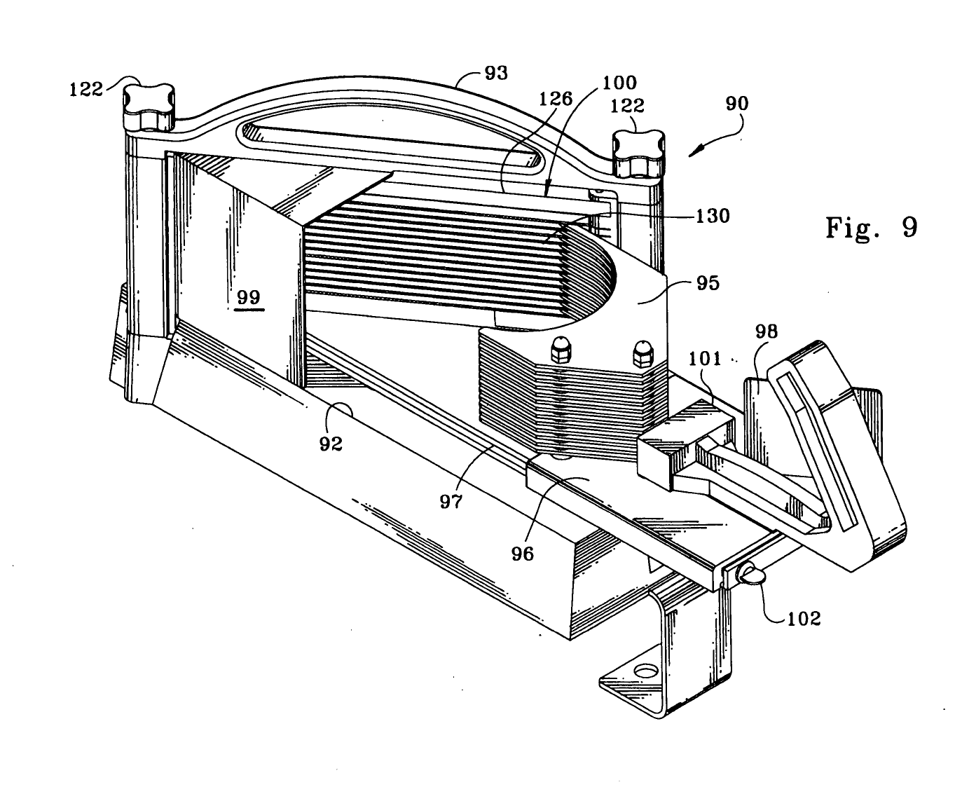

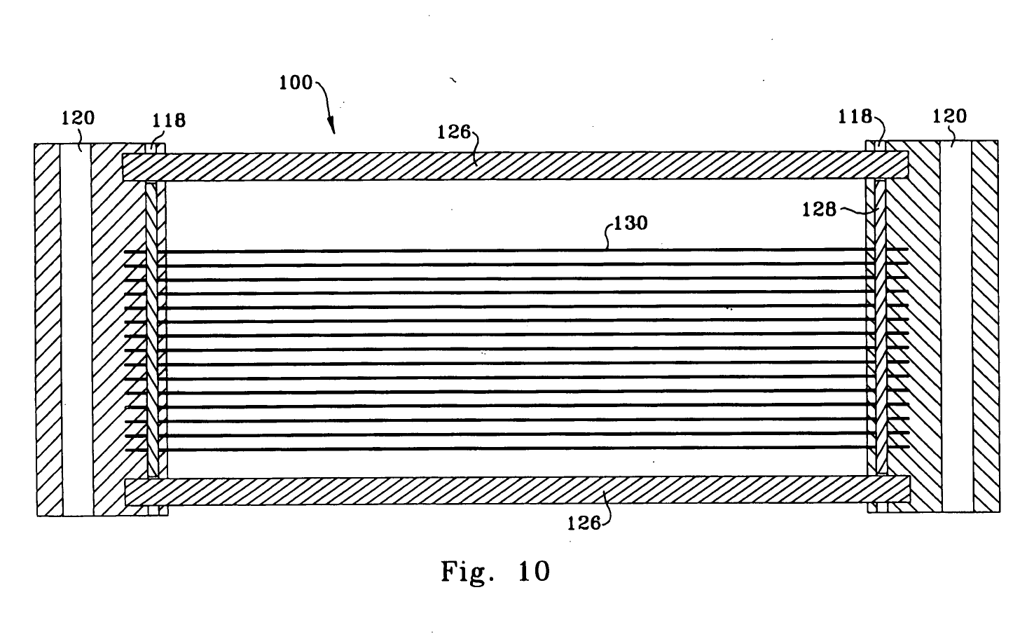

FIG. 9 illustrates a slicer 90 having a blade assembly 100 fitted therein. A sectional view of the blade assembly is shown in FIG. 10, removed from slicer 90. In this case, the blades 130 in the blade assembly are oriented horizontally, rather than vertically as in the slicers of FIGS. 6 and 8. This slicer is also used for slicing produce, such as tomatoes. In the embodiment shown, there are 14 blades, although other numbers and spacings of blades may be substituted. The blades are maintained in the assembly by way of tension rods 128 passing through apertures at the longitudinal ends of each blade 130 as before. Tension may be created in the blades with a fixture as shown in FIG. 7, and the tension may be maintained therein by the insertion of tension bars 126.

Blade assembly 100 used in slicer 90 differs slightly from blade assembly 10, in that tension block hole 120 is preferably oriented generally parallel to hole 118, rather than perpendicular as in the previous designs. This arrangement facilitates the fixation of blade assembly 100 in slicer 90, as shown in FIG. 9. A suitable threaded rod (not shown) engaged with a screw head 122 may be inserted through hole 120, to secure the blade assembly 100 to slicer frame 92.

Frame 92 and bridge 93 are proportioned for good foundry practice. The arrangement shown permits easy installation of the blade assembly 100, as well as simple removal of the blade assembly for cleaning, repair, or replacement. In this embodiment, it is generally preferred to orient the blade assembly 100 at an angle of between about 30° and 45°, more preferably about 35°, to the axis in the direction the produce is pushed, thereby achieving a “shearing” action while slicing. An angle of 30° to 45° is common in machines of this type.

Slicer 90 also includes a pusher assembly 95 for pushing the produce through the blade assembly 100. Pusher assembly 95 is similar to the design of other existing machines currently in use. Preferably, pusher assembly 95 co-acts with a conventional movable portion, such as a slide board 96 having grooves 97 on the outer edges, to guide the pusher assembly as thrust is applied to push the tomato in an axial direction through the blade assembly 100. This action is consistent with existing devices.

The bridge 93 provides structural integrity to the slicer 90, and is designed to facilitate easy handling. Conventional guards 98 and 99 may be provided for operator safety. The pusher assembly 95 may be retained upon the slide board 96 by any suitable means, such as stop 101 and thumbscrews 102. This permits simple removal of the pusher assembly 95 for cleaning. A table stop 105 may be provided to retain the machine's position on the work surface while in use, and to hang it for storage when not in use.

Other features of slicer 90 that have not been described herein are conventional, and further explanation is not required for a full understanding of the present invention. In addition, many of the features described are conventional, and have been discussed only to provide general direction of the operation of slicer 90. Those skilled in the art will appreciate that slicer 90 is only one example of numerous possible designs that may be used with a horizontally-aligned set of blades according to the present invention, all of which are considered within the scope of the invention.

Those skilled in the art will appreciate that the components, such as the blades and the tension bars, can be made to any desired length, such that any desired level of stress may be established and maintained on the blades. Since the blade assemblies 10, 100, described herein are each unitized, they may each be easily handled as a separate entity. The simple manufacturing processes result in an economical component, and a candidate for “throw-away” replacement. However, if desired, the blade assembly can simply be recycled if the blades should become dull or damaged. In this event, the tension can be removed in the system by cutting the blades, thereby releasing the tension on the tension blocks, and allowing the blade assembly 10, 100 to come apart. Replacement blades 30, 130 can be installed in the same manner as the original blades, and suitable tension can be re-established in the blades as described previously. This action may conveniently occur pursuant to a manufacturer's “return-and-exchange” type program. In this manner, the customer simply returns the damaged or worn blade assembly, and is provided with a replacement assembly, fully tensioned and in condition for further use.

When utilizing a slicer having a unitized blade assembly 10, 100 as shown, the machine frame does not require extra strength considerations to accommodate the stresses of the initial tension of the blades. By using extruded aluminum components, the components can be made lighter than in comparable devices.

The present invention provides at least the following benefits when compared to prior art devices:
1) Ease of manufacturing;
2) Reduced costs of both the blade system and the machine in which it is utilized;
3) Simplicity of blade system replacement;
4) Simplicity of blade system removal for cleaning;
5) A smaller, lighter weight machine for convenient handling and utilization;
6) A unitized blade system, which can be priced economically, allowing it to be considered a “throw-away” item when blade replacement is warranted;
7) Although a possible “throw-away” item, the unitized blade system can be easily and economically repaired with new blades by a repair station that is capable of re-establishing the blade tension;
8) May be made to be compatible with well-known features of existing slicers, such as the feature of a plastic slide board with grooves on the sides to guide the pusher; and
9) Prevents improper installation of the blade system into the slicing machine.

It is therefore intended that the foregoing detailed description be regarded as illustrative rather than limiting, and that it be understood that it is the following claims, including all equivalents, that are intended to define the spirit and scope of this invention.

1. A blade assembly for use in a slicing device, the blade assembly comprising:
a plurality of blades;
a pair of tension members, each tension member having a plurality of slots formed therein, said tension members being positioned such that said slots in one tension member are disposed generally opposite said slots in the other tension member, said tension members being spaced such that a longitudinal end of a blade is received in each of said generally opposite slots, and that said blade is maintained therebetween under tension;
a retainer associated with each of said tension members for retaining said blade longitudinal end in said tension member slot; and
a spacer for maintaining said spacing between said tension members to maintain said blade tension.

2. The blade assembly of claim 1, wherein at least one of said tension members includes an opening extending longitudinally along said tension member and through said slots, and wherein said respective blade ends receivable in said slots include an aperture extending therethrough, said tension member opening and said blade apertures being aligned such that said retainer is receivable therethrough, said retainer comprising an elongated member extending substantially the length of said longitudinal opening.

3. The blade assembly of claim 2, wherein said spacer comprises a first spacing member having sufficient size and strength to maintain said spacing, said spacing member disposed at a longitudinal end of said tension member and spanning said space between said tension members, said blade assembly further comprising a second spacing member disposed at the other longitudinal end of said tension member and spanning said space between said tension members.

4. The blade assembly of claim 3, wherein said tension members include respective cut-out portions for receiving respective ends of said spacing members.

5. The blade assembly of claim 1, wherein each of said tension members includes an opening extending longitudinally therethrough, said opening passing through said tension member slots, and wherein each of said blades includes an aperture at each longitudinal end thereof, said respective longitudinal openings and apertures being aligned such that said retainer is receivable therethrough, said retainer comprising an elongated rod extending substantially the length of said longitudinal opening.

6. The blade assembly of claim 5, wherein said spacer comprises a first spacing member having sufficient size and strength to maintain said spacing, said spacing member disposed at a longitudinal end of said tension member and spanning said space between said tension members, said blade assembly further comprising a second spacing member disposed at the other longitudinal end of said tension member and spanning said space between said tension members.

7. A method for forming a blade assembly, comprising:
providing a pair of tension members, each tension member having a plurality of blade-receiving slots formed therein, each tension member further having an opening for receiving a spacer, each tension member further having a hole longitudinally extending through at least a portion of said tension member, said hole passing through said blade-receiving slots in said tension member;
aligning said tension members so that said blade-receiving slots in each said tension member face each other;
providing a plurality of blades, each blade having opposing longitudinal ends and having an aperture at each of said longitudinal ends;
inserting one longitudinal end of each of said blades into a respective blade-receiving slot in one tension member and the other longitudinal end of each said blade into the opposing slot in the other tension member such that said blade apertures are aligned with the hole extending through a respective tension member;
inserting a respective elongated member through each tension member hole and said aligned blade aperture;
aligning the tension members having the blades inserted therein in a fixture, and activating the fixture to controllably increase the spacing between the tension members to establish a tension in the blades extending therebetween, and to create sufficient distance between the tension members such that a spacer can be inserted between corresponding spacer openings to maintain said spacing;
providing a spacer having a length such that said spacer is insertable into said spacing between said opposing tension members, said spacer having sufficient strength for maintaining a selected distance between said tension members;
inserting said spacer into said spacing between opposing tension members; and
adjusting the fixture to allow the tension members to move toward each other a specified distance to seat the spacer in said corresponding spacer openings, thereby establishing a fixed distance between said tension blocks and maintaining a desired tension in said blades.

8. The method of claim 7, wherein each tension member includes two openings for receiving respective spacers, and wherein said method comprises providing two spacers having said length and strength, and inserting each of said spacers into said spacing such that each said spacer is seated in respective corresponding spacer openings.

9. The method of claim 8, wherein said tension members include respective cut-out portions for receiving respective ends of said spacers.

10. The method of claim 7, wherein each said elongated member comprises a generally cylindrical rod.

11. A food slicing device, comprising:
a frame;
a blade assembly removably fitted into said frame, the blade assembly comprising: a plurality of blades; a pair of tension members, each tension member having a plurality of slots formed therein, said tension members being positioned such that said slots in one tension member are disposed generally opposite said slots in the other tension member, said tension members being spaced such that a longitudinal end of a blade is received in each of said generally opposite slots, and said blade is maintained therebetween under tension; a retainer associated with each of said tension members for retaining said blade longitudinal end in said tension member slot; and a spacer for maintaining said spacing between said tension members to maintain said blade tension.

12. The food slicing device of claim 11, further comprising a pusher for pushing a food product through said blade assembly.

13. The food slicing device of claim 12, further comprising a guide mechanism, wherein said pusher rides on said guide mechanism when pushing said food product.

14. The food slicing device of claim 12, wherein said pusher is pivotally engaged with said frame.

15. The food slicing device of claim 12, further comprising at least one stop mechanism engaged with said frame to inhibit movement of said slicing device during operation of said device.

16. The food slicing device of claim 11, wherein each of said tension members of said blade assembly includes an opening extending longitudinally therethrough, said opening passing through said tension member slots, and wherein each of said blades includes an aperture at each longitudinal end thereof, said respective longitudinal openings and apertures being aligned such that said retainer is receivable therethrough.

17. The food slicing device of claim 16, wherein said spacer of said blade assembly comprises a first elongated member having sufficient size and strength to maintain said spacing, said elongated member disposed at a longitudinal end of said tension member and spanning said space between said tension members, said blade assembly further comprising a second elongated member disposed at the other longitudinal end of said tension member and spanning said space between said tension members.

18. The food slicing device of claim 17, wherein said tension members include respective cut-out portions for receiving respective ends of said elongated members.

19. The food slicing device of claim 11, wherein said blade assembly is positioned in said frame in a manner such that said blades are oriented vertically.

20. The food slicing device of claim 11, wherein said blade assembly is positioned in said frame in a manner such that said blades are oriented horizontally.
